(19) United States
(12) Patent Application Publication
(10) Pub. No.: US 2002/0097775 A1
(43) Pub. Date: Jul. 25, 2002

(54) Heat sensing device for thermal and skin burn evaluation

(76) Inventors: Hechmi Hamouda, Raleigh, NC (US); Roger L. Barker, Cary, NC (US); Robert Grimes, Apex, NC (US)

Correspondence Address: JENKINS & WILSON, PA, 3100 TOWER BLVD, SUITE 1400, DURHAM, NC, 27707, US

(21) Appl. No.: 09/938,091

(22) Filed: Aug. 23, 2001

Related U.S. Application Data
(60) Provisional application No. 60/228,681, filed on Aug. 29, 2000.

(51) Int. Cl. G01K 17/00

(52) U.S. Cl. 374/29

(57) ABSTRACT

A heat sensor device adapted to provide direct measurements of heat flux to be used for calculating thermal and skin burn predictions. The device comprises a copper disk within a copper thermal guard ring that are supported within a heat insulating disk holder surrounded by a protective housing. A thermocouple is affixed to the back side of the copper disk in a cavity defined within the heat insulating disk holder, and a connector wire extends through the heat insulating disk holder and protective housing.

### TECHNICAL FIELD

The present invention relates generally to heat sensor devices. More particularly, the present invention relates to an improved device for thermal and skin burn evaluation that utilizes direct measurement of heat flux in order to obtain precise heat flux measurement so as to determine accurate thermal and skin burn evaluation data.

### RELATED ART

Laboratory test methods for evaluating the thermal protective performance (TPP) of clothing material must rely on instrumental measurements of the heat flux penetrating the test fabric and a mathematical model for translating thermal measurements to predict physiological skin burn injury. Over the past decade or more, several different types of sensor devices have been developed and used for this particular application. Although all of the previously developed devices have generally performed in accordance with at least minimal performance expectations, there has been a long-felt need for a new and improved sensing device for developing precise thermal and skin burn evaluations. Applicants have discovered such a heat sensor device and the device will be described in detail hereinafter.

First, as background, applicants wish to briefly describe the structure and functionality of four representative conventional sensors and one additional novel sensor used in the measurement of transient heat flux resulting from a flash-fire or steady heat source short exposure and assessment of resulting human skin burn damage in a laboratory test method environment. The specific application of the sensors is to evaluate the thermal protective performance (TPP) of clothing materials in the laboratory. In this respect, one previous sensor is well-known to those skilled in the art as the THERMOGAUGE™ sensor. The THERMOGAUGE™ sensor, available from Vatell Corporation of Blacksburg Va., is a circular foil heat flux gauge that operates by measuring the temperature differential between the center and the circumference of a thin constantan foil disk. The constantan foil disk is bonded to a cylindrical copper heat sink, and the incident heat is drawn towards the heat sink away from the center of the constantan foil. This produces a temperature drop across the constantan foil which is measured by a thermoelectric junctions in the center of the constantan foil and the outer copper heat sink. The voltage output from the sensor is read and then combined with a calibration coefficient provided by the manufacturer to calculate the absorbed heat flux.

Another conventional sensor well-known to those skilled in the art is the HY-THERM® sensor available from Hy-Cal Sensing Products of El Monte, Calif. This sensor consists of an insulating wafer with a series of thermocouples embedded in the backside of the wafer in such a way that the thermoelectric junctions are positioned on opposite sides of the insulating wafer. The wafer is mounted to a heat sink that draws the incident heat. A temperature drop will result across the wafer and the thermocouples will respond to the temperature drop. The thermocouples are connected in series so as to provide an additive or amplified response in signal output. The signal output is then proportional to the heat flux incident upon the sensor.

Another conventional sensor is the TPP (Thermal Protective Performance) sensor, available from Custom Scientific Instrument Inc., which comprises an insulated copper slug calorimeter. The TPP sensor is not cooled and has been proven in industrial applications as a rugged and reliable sensing device that is well established for use to measure heat flux measurements and predict human tissue damage.

Yet another conventional sensor well-known to those skilled in the art is the THERMOMAN™ sensor (also known as the “Embedded Thermocouple Sensor”). This type of sensor is currently in use (but is soon to be replaced by the Pyrocal sensor of the present invention) in a testing laboratory at the College of Textiles of North Carolina State University in Raleigh, N.C.. on a full scale mannequin used to test flame retardant garments. The THERMOMAN™ sensor used in the mannequin testing of flame retardant garments is a thin-skin calorimeter which utilizes a T-type thermocouple which is buried below the exposed surface of a cast thermoset polymer resin plug at a depth of about 0.17 mm (0.005 inches). Scientists who work in the testing laboratory report that the polymer exhibits a thermal inertia similar to that of undamaged human skin. Thus, the Embedded Thermocouple Sensor is designed with a frontal thickness greater than 6.35 mm (0.25 inches) so that temperature conditions along the rear side of the sensor will not affect the response of the sensor surface measurements. This allows the sensor to be considered an infinite thickness slab utilizing the infinite slab geometry for the exposure. The depth of the thermocouple is critical to the analysis of heat flux in this sensor, and thus a computer program was used to calculate heat flux.

Finally, a fifth and novel water cooled sensor (Pyrocool) is described herein that has been developed at the College of Textiles of North Carolina State University and is the subject matter of co-pending and commonly assigned U.S. patent application Ser. No. ______ filed ______ in the U.S. Patent and Trademark Office. The sensor is a water cooled, heat sensing thermocouple with cooling auxiliaries that measures the temperature of water flowing through the system. The temperature rise in the coolant is calibrated to known levels of incident heat flux. This novel water cooled sensor is used in testing described herein along with the four conventional sensors to evaluate the relative performance of the novel heat flux sensor of the present invention.

Most of the sensors described above possess certain disadvantages which has led to a long-felt need for an improved heat flux sensor device. Disadvantages of many previous heat flux sensors include known heat leakage from the sensor, limited durability, errors due to inaccurate thermocouple bead location, polymer cracks with repetitive testing exposures and undesirably large and bulky housings required to insulate sensors against heat loss. These shortcomings and others have been overcome by the novel heat flux sensor discovered by the applicants and described and claimed herein.

### SUMMARY OF THE INVENTION

In accordance with the present invention applicants have discovered a novel heat sensor device adapted for direct measurement of heat flux and comprising a copper disk having a front side and a back side, and a thermal guard copper ring positioned around the copper disk. A heat insulating disk holder is provided to support the copper disk and thermal guard copper ring therein with the front side of the copper disk facing outward and defining an insulating air cavity adjacent the backside of the copper disk and within the heat insulating disk holder. A protective housing is provided for receiving the insulating disk holder therein, and a thermocouple is affixed to the backside of the copper disk and located in the air cavity therebehind. The thermocouple has an electrical connector wire extending from the thermocouple and through the insulating disk holder and the protective housing and extremely outwardly therefrom.

Therefore, it is an object of the present invention to provide a heat sensor device for accurately measuring transient heat flux resulting from flash-fire or a steady heat source short exposure so as to reliably assess resulting human skin burn damage potential.

It is another object of the present invention to provide a heat sensor device that allows for direct measurement of heat flux as opposed to an indirect measurement of heat flux in order to provide a more accurate assessment of potential skin burn damage during garment flammability testing.

It is still another object of the present invention to provide a heat sensor device that provides a consistent and stable reading over a wide range of thermal exposures of interest in laboratory testing of garment flammability and that is smaller and less bulky than conventional and well-known heat sensors.

It is still another object of the present invention to provide a heat sensor device that is highly durable in use in laboratory testing of garment flammability and potential human skin burn damage.

It is still another object of the present invention to provide a heat sensor device that obviates the necessity for using an inverse heat transfer calculation to estimate heat flux and the errors associated with this calculation by providing for accurate direct heat flux measurement.

Some of the objects of the invention having been stated, other objects and advantages of the inventive heat sensor device will become apparent as the description proceeds when taken in connection with the accompanying drawings as described hereinbelow.

### BRIEF DESCRIPTION OF THE DRAWINGS

FIG. 1 is a perspective view of the heat flux sensor device of the present invention;

FIG. 2 is a side elevation and exploded view of the heat flux sensor device shown in FIG. 1;

FIG. 3 is a perspective and exploded view of the heat flux sensor device shown in FIG. 1;

FIG. 4 is a vertical cross-sectional and exploded view of the heat flux sensor device shown in FIG. 1;

FIG. 5 is a view of a RPP (Radiant Protective Performance) test stand;

FIG. 6 is a graph of the performance of the heat flux sensor device shown in FIG. 1 and five other sensors when exposed to 2.5 kW/m² heat flux level for 5 minutes;

FIG. 7 is a graph of the performance of the heat flux sensor device shown in FIG. 1 and three other sensors when exposed to 6.3 kW/m² heat flux level for 5 minutes;

FIG. 8 is a graph of the performance of the heat flux sensor device shown in FIG. 1 and three other sensors when exposed to 9.6 kW/m² heat flux level for 5 minutes; and

FIG. 9 is a table of the performance of the heat flux sensor device shown in FIG. 1 and four other sensors regarding predicted time to second degree burn based on performance data gathered at 6.3 kW/m² and 9.6 kW/m² heat flux levels.

### BEST MODE FOR CARRYING OUT THE INVENTION

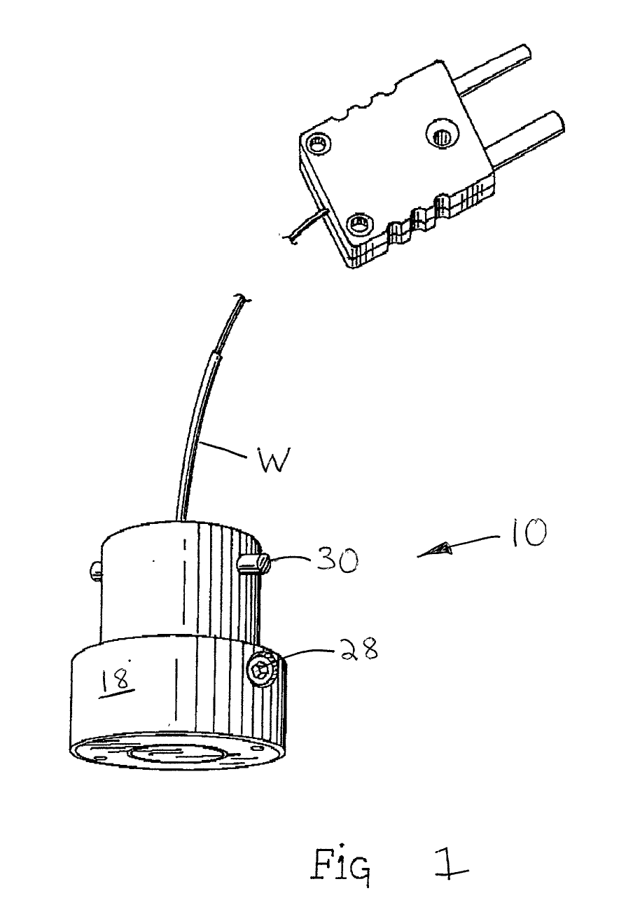

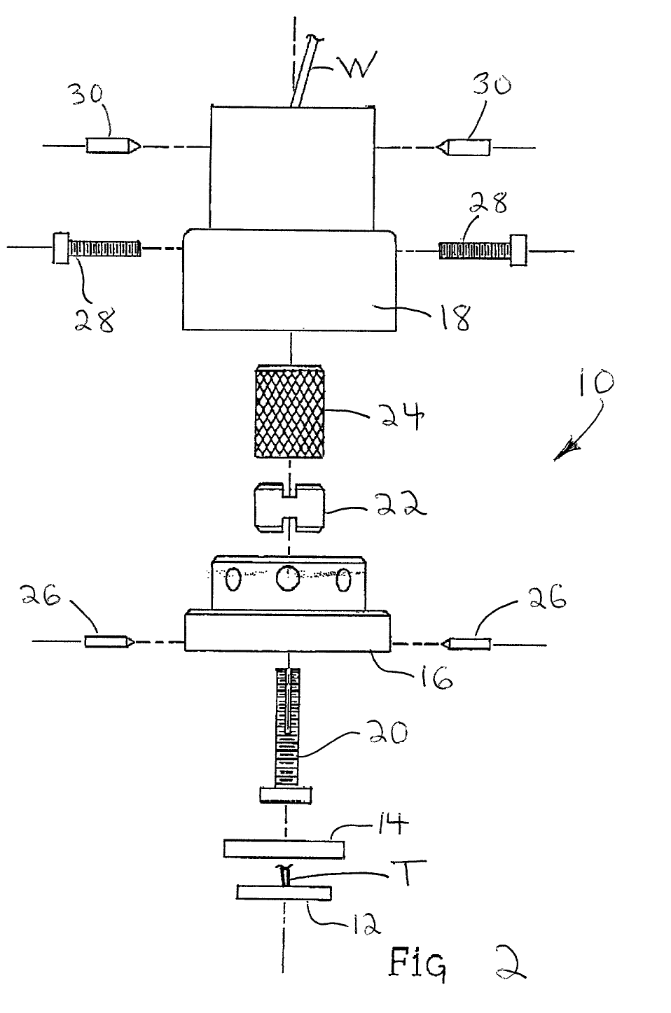

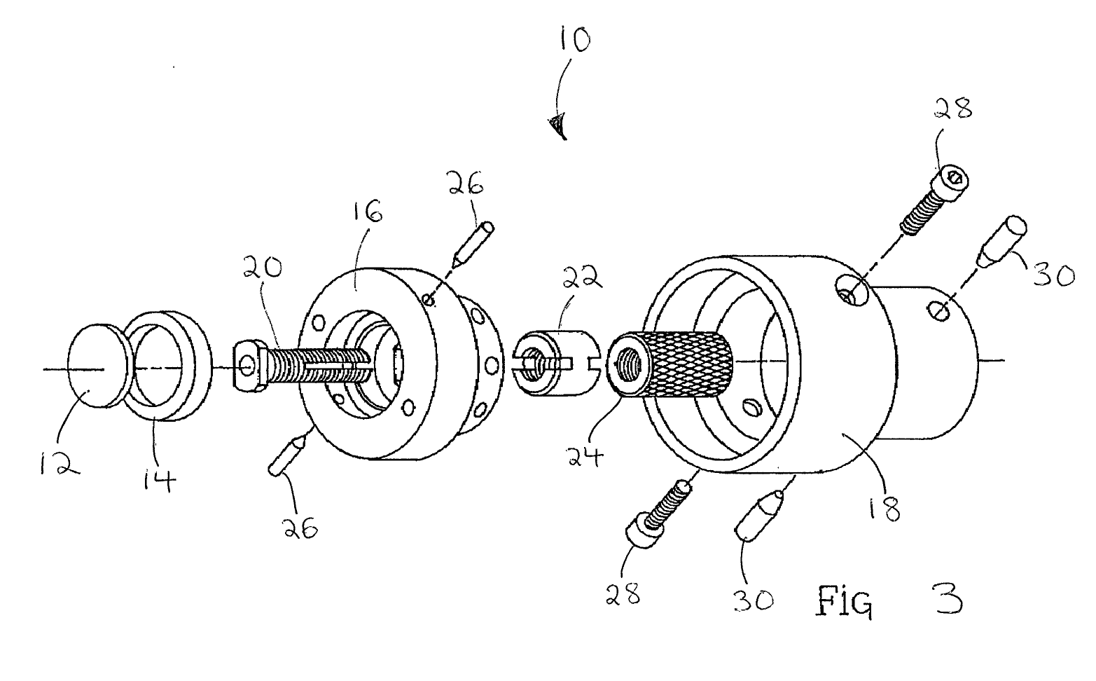

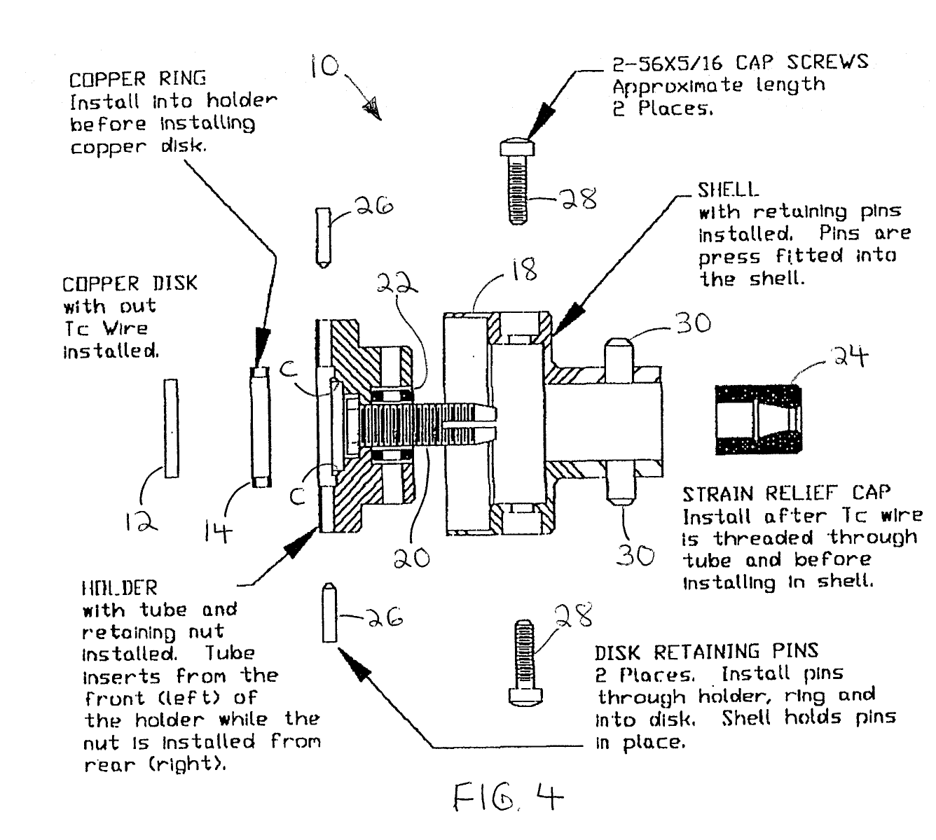

Referring now to FIGS. 1-9 of the drawings, the heat flux sensor of the present invention is shown and generally designated 10. Heat sensor 10 is a slug-type thermal sensor developed by applicants for use in flame retardant garment testing on a test mannequin at the College of Textiles of North Carolina State University in Raleigh, N.C. Sensor 10 comprises a thin copper disk 12, preferably between about 0.438 and 0.440 cm in diameter and 0.060 and 0.061 cm in thickness surrounded by a thin copper thermal guard ring 14. Copper disk 12 and copper thermal guard ring 14 are supported by insulating disk holder 16 (which is preferably formed of copper) to minimize heat transfer to and from the body of the calorimeter. Behind the back side of copper disk 12 is an insulating air cavity C (see FIG. 4) defined within insulating disk holder 16, and a T-type (copper-constantin) thermocouple T is attached to the backside of copper disk 12. Insulating disk holder 16 containing copper disk 12 and copper thermal guard ring 14 are positioned in and encapsulated by protective shell 18. Protective shell 18 is most suitably formed of aluminum or stainless steel.

As can further be seen with reference to FIGS. 1-9 of the drawings, a connector wire W is attached to thermocouple T (preferably a T-type brand thermocouple available from Omega Engineering Inc.) and extends rearwardly from thermocouple T affixed to copper disk 12 through an externally threaded strain relief tube 20; retaining nut 22; strain relief cap 24; and outwardly from the rear of protective shell 1 8. Strain relief tube 20 is positioned in a central aperture in insulating disk holder 16 and secured in place by retaining nut 22 to insulating disk holder 16. Strain relief cap 24 is threaded onto the end of strain relief tube 20 to protect thermocouple T from tensile forces. Two disk retaining pins 26 are installed through apertures in insulating disk holder 16 and copper thermal guard ring 14 to secure and retain copper disk 12 in place. Also, two cap screws 28 are inserted through protective shell 18 and threaded into corresponding apertures in insulating disk holder 16 to secure and hold insulating disk holder 16 securely in place. Also, two additional retaining pins 30 are press fit into protective shell 18 and into contact with strain relief cap 24 to further hold and secure insulating disk holder 16 in place within protective shell 18.

To summarize, heat flux sensor 10 can be assembled by installing copper disk 12 and copper ring 14 into the front face of insulating disk holder 16 with thermocouple T affixed to the back side of copper disk 12. Next, strain relief tube 20 is inserted into the front side of disk insulating holder 16 and partially through an aperture therein. Next, assembly or retaining nut 22 is installed from the backside of insulating disk holder 16 to secure strain relief tube 20 in place within insulating disk holder 16. As noted hereinbefore, a space is defined between the back surface of copper disk 12 and the top surface of strain relief tube 20 within insulating disk holder 16. The two disk retaining pins 26 are installed in insulating disk holder 16 and through copper ring 14 and into disk 12 to secure disk 12 in place. Next, strain relief cap 24 is installed after connector wire W to thermocoupler T attached to the back surface of copper disk 12 is threaded through strain relief tube 20. Finally, insulating disk holder 16 is inserted into protective shell 18 and secured therewithin by two cap screws 28 and two press fit retaining pins 30. The fully assembled heat flux sensor device 10 is of compact size and provides a unique capability for highly accurate direct measurement of heat flux during flame retardant garment testing in order to accurately predict skin burn damage.

Experimental Testing

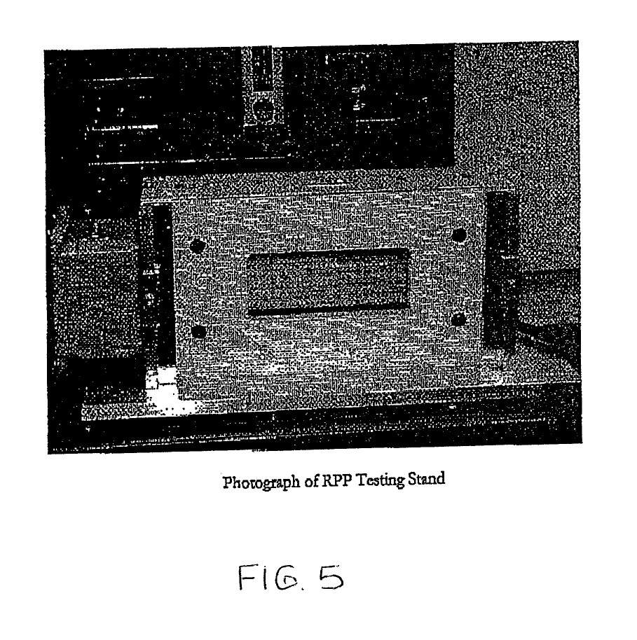

In conducting a comparative study of the performance of different sensors, an RPP (Radiant Protective Performance) test platform was used. A view of the RPP testing stand can be seen in FIG. 5. The RPP contains a mounting assembly that is 5.0 inches by 5.0 inches by 2.0 inches high. It uses quartz radiant heater tubes to provide a stable heat source. The RPP tester utilizes a heat shield that acts as a barrier prior to starting a test exposure.

Direct Exposure

To compare their performance and response accuracy, the six sensors (including sensor 10) were directly exposed, for 5 minutes, to a 2.5 kW/m²heat flux level that approximates the range commonly sensed behind thermal protective fabrics. The evaluated sensors, as previously described, were the THERMOGAUGE™; HY-THERM®; water cooled (Pyrocool); TPP; THERMOMAN™; and heat sensor 10 of the invention.

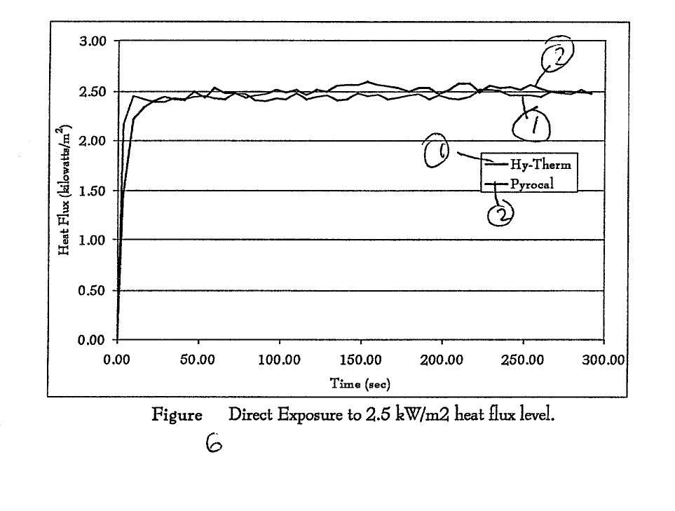

During the exposure, as shown in FIG. 6, both sensor 10 and TPP sensors have the shortest response time. However, as the exposure time elapses and within 20 seconds the temperature response of these two sensors drifts apart and away from the responses of the remaining sensors. Besides the THERMOGAUGE™ sensor, the remaining three sensors accurately track the incident heat flux level up to 2 minutes of exposure. At this time, the THERMOMAN™ sensor response starts drifting down apart from the response of the remaining sensors. Toward the end of the 5 minutes exposure time, both HY-THERM®, and the water cooled (Pyrocool) sensors are still accurately tracking the incident heat flux. In spite of its steady constant response, the THERMOGAUGE™ sensor consistently generates a low reading of the incident heat flux.

This exposure based on a known heat flux level sets the needed performance confirmation of the different sensors. It shows that, up to approximately 2 minutes of exposure, three sensors: HY-THERM®, Pyrocool and THERMOMAN™ perform comparatively in tracking the incident heat flux level. Beyond the 2 minutes period only the HY-THERM® and the Pyrocool sensors remain generating a steady response throughout the 5 minutes of exposure.

RPP (Radiant Protective Performance) Exposure

Four out of the previous six sensors were used in an RPP exposure test setup (see FIG. 5) with a composite fire fighter fabric system inserted between the heat source and the sensors. The HY-THERM® sensor was eliminated from this experiment to prevent damage due to fabric degradation residues. The THERMOGAUGE™ sensor was also eliminated for its consistent low reading of the heat flux level. Two heat flux levels of 6.3 and 9.6 kW/m² were used during this experiment that was conducted to evaluate the sensors' response to heat flux through fabric systems and predict the time to second degree burn based on each individual sensor response.

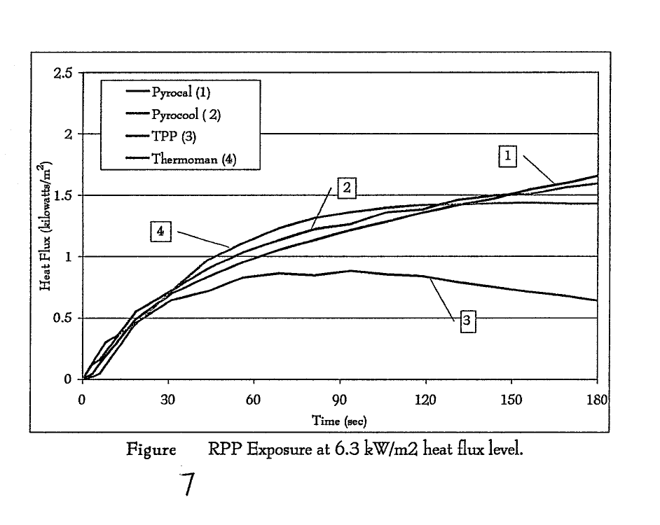

At the 6.3 kW/m² level, as shown in FIG. 7, apart from the THERMOMAN™ sensor which generates a higher response throughout the first 2 minutes of exposure, the water cooled (Pyrocool) sensor exhibits the shortest response time followed by sensor 10 and then the TPP sensor. However, as the exposure time elapses and within 1 minute both responses of sensor 10 and TPP sensors start drifting apart whereas the water cooled (Pyrocool) sensor continues tracking the sensed heat flux. Beyond the first 2 minutes of exposure, the THERMOMAN™ sensor starts its downward trend due to sensor heat storage.

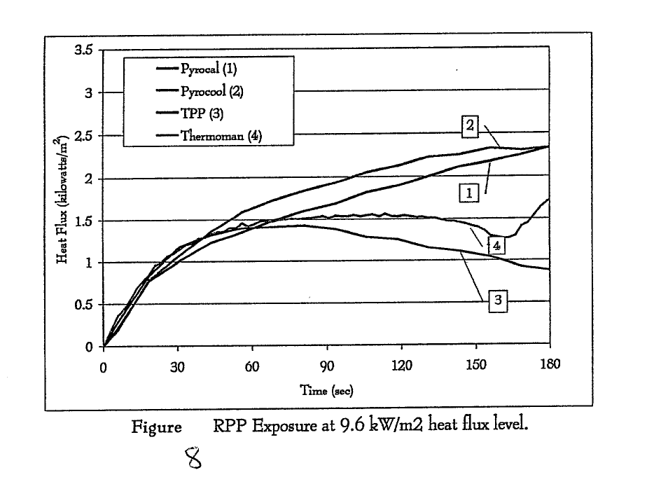

When exposed to the next heat flux level of 9.6 kW/m², as shown in FIG. 8, the response time and the heat flux readings of all four sensors are comparable during the initial 30 seconds of exposure except for the THERMOMAN™ sensor that generates a higher response. For the remaining exposure time, both sensor 10 and the TPP sensors drift apart and away from the responses fo the remaining sensors. The trends of both the water cooled (Pyrocool) and sensor 10 are similar to those exhibited during the previous exposure.

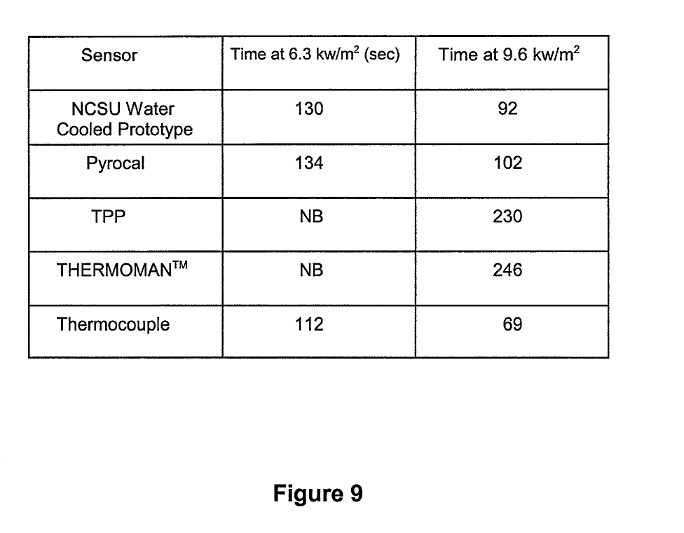

From these results and an additional temperature measurement based on a conventional thermocouple attached to the backside of the fabric, time to second-degree burn was calculated based on the Stoll's criteria for sensor 10; water cooled (Pyrocool); and TPP sensors. A burn prediction program was used to determine the time to second-degree burn for the THERMOMAN™ sensors. The 55° C. criterion was used in association with the thermocouple data. FIG. 9 shows these results as predicted with the five different sensors (including the thermocouple additional temperature measurement). At the 6.3 kW/m² heat flux level, the TPP sensor predicts no second-degree burn. Meanwhile, the THERMOMAN™ sensor predicts the longest time to second degree burn, 284 seconds, followed by sensor 10, water cooled (Pyrocool) and finally the thermocouple which predict the shortest time of 112 seconds. The trend is the same at the 9.6 kW/m² heat flux level, the TPP sensor predicts the longest time to second degree burn, 230 seconds, while 69 seconds is the shortest time as predicted by the thermocouple. Results obtained based on the readings of both sensor 10 and water cooled (Pyrocool) sensors are in agreement.

Summarily, since it was shown and verified that both sensor 10 and the water cooled (Pyrocool) sensor closely track the incident heat flux during for at least the initial 2 minutes of direct exposure, the final prediction of the time to second-degree burn based on these two sensors should be the most accurate. Additionally, both these predictions were obtained based on a direct reading of heat flux from the fabric surface opposite to the heat source while other sensors including the THERMOMAN™ and the thermocouple rely on indirect methods of heat flux evaluation or burn time prediction.

Applicants wish to note that although a specific application of sensor 10 is described herein, the applicants contemplate many other applications for sensor 10 and intend for all applications to be within the scope of the invention. Further, applicants again note that the newly-discovered water cooled (Pyrocool) sensor described above is not a conventional heat flux sensor although included in the tests described herein as an additional data source. It is, in fact, novel and the subject matter of co-pending and commonly assigned U.S. patent application Ser. No. ______ filed ______. It will be understood that various details of the invention may be changed without departing from the scope of the invention. Furthermore, the foregoing description is for the purpose of illustration only, and not for the purpose of limitation—the invention being defined by the claims.

What is claimed is:

1. A heat sensor device adapted for direct measurement of heat flux and comprising:
(a) A copper disk having a front side and a back side, and a thermal guard copper ring positioned around said copper disk;
(b) a heat insulating disk holder for supporting said copper disk and thermal guard copper ring therein with the front side of said copper disk facing outward and defining an insulating air cavity adjacent the back side of said copper disk and within said heat insulating disk holder;
(c) a protective housing for receiving said insulating disk holder therein; and
(d) a thermocouple affixed to the back side of said copper disk and located in said air cavity therebehind and having an electrical connector wire extending from said thermocouple and through said insulating disk holder and said protective housing.

2. The heat sensor device according to claim 1 wherein said copper disk is between about 0.438 to 0.440 centimeters in diameter and between about 0.060 to 0.061 in thickness.

3. The heat sensor device according to claim 2 wherein said copper disk is about 1.27 centimeters in diameter and 0.15 centimeters in thickness.

4. The heat sensor device according to claim 1 wherein said heat insulating disk holder is formed of copper.

5. The heat sensor device according to claim 4 including a plurality of pins extending through said disk holder and thermal guard copper ring to retain said copper disk in place.

6. The heat sensor device according to claim 1 wherein said protective housing is formed of aluminum or stainless steel.

7. The heat sensor device according to claim 6 including a plurality of caps screws extending through said protective housing and into said heat insulating disk holder to retain said heat insulating disk holder in place.

8. The heat sensor disk device according to claim I wherein said thermocouple is a T-type (copper-constantine) thermocoupler.

9. The heat sensor disk device according to claim 1 wherein said thermocouple electrical connector wire extends from said thermocouple affixed to the back side of said copper disk and through said heat insulating disk holder and said protective housing and outwardly from said protective housing.

10. The heat sensor disk device according to claim 9 wherein said electrical connector wire extends through a strain relief tube and strain relief cap provided within said heat sensor device.

11. The heat sensor device according to claim 10 wherein said strain relief tube is secured within said heat insulating disk holder with a retaining nut.

12. The heat sensor device according to claim 1 1 wherein a plurality of pins extend through said protective housing and into contact with said strain relief cap to secure said heat insulating disk holder within said protective housing.

13. A heat sensor device adapted for direct measurement of heat flux and comprising:
(a) A copper disk having a front side and a back side, and a thermal guard copper ring positioned around said copper disk;
(b) a heat insulating disk holder formed of copper for supporting said copper disk and thermal guard copper ring therein with the front side of said copper disk facing outward and defining an insulating air cavity adjacent the back side of said copper disk and within said heat insulating disk holder;
(c) a protective housing formed of aluminum or stainless steel for receiving said insulating disk holder therein; and
(d) a thermocouple affixed to the back side of said copper disk and located in said air cavity therebehind and having an electrical connector wire extending from said thermocoupler through a strain relief tube and strain relief cap within said insulating disk holder and said protective housing and outwardly from said protective housing.

14. The heat sensor device according to claim 13 wherein said copper disk is between about 0.438 to 0.440 centimeters in diameter and between about 0.060 to 0.061 in thickness.

15. The heat sensor device according to claim 14 wherein said copper disk is about 1.27 centimeters in diameter and 0.15 centimeters in thickness.

16. The heat sensor device according to claim 13 including a plurality of pins extending through said disk holder and thermal guard copper ring to retain said copper disk in place.

17. The heat sensor device according to claim 13 including a plurality of cap screws extending through said protective housing and into said heat insulating disk holder to retain said heat insulating disk holder in place.

18. The heat sensor disk device according to claim 13 wherein said thermocouple is a T-type (copper-constantin) thermocouple.

19. The heat sensor device according to claim 13 wherein said strain relief tube is secured within said heat insulating disk holder with a retaining nut.

20. The heat sensor device according to claim 13 wherein a plurality of pins extend through said protective housing and into contact with said strain relief cap to secure said heat insulating disk holder within said protective housing.
